(19) United States
(12) Patent Application Publication
(10) Pub. No.: US 2025/0293610 A1
(43) Pub. Date: Sep. 18, 2025

(54) PRIMARY SIDE REGULATED SELF OSCILLATING FLYBACK CONVERTER

(71) Applicant: Murata Manufacturing Co., Ltd., Nagaokakyo-shi (JP)

(72) Inventor: Frank WARNES, Milton Keynes (GB)

(21) Appl. No.: 19/081,310

(22) Filed: Mar. 17, 2025

(30) Foreign Application Priority Data
Mar. 18, 2024 (GB) 2403827.5

(51) Int. Cl. H02M 3/338; H02M 3/335

(52) U.S. Cl. CPC H02M 3/338; H02M 3/33569

(57) ABSTRACT

A flyback converter includes a transformer, a switching circuit, and a regulating circuitry coupled with a primary winding circuit of the transformer. The switching circuit includes a primary switch which is switchable between an ON state and an OFF state and a switch coupled to the primary switch of the primary winding circuit. The switch is configured to change the state of the primary switch in response to a current change in the primary winding circuit under normal operation. The regulating circuit includes a regulator coupled between the switch and the primary winding. The regulator is configured to feed an additional current to the switch in response to a voltage applied from the primary winding to the regulator. In response to the additional current fed by the regulator, the switch is urged to change the state of the primary switch earlier than under normal operation.

### CROSS REFERENCE TO RELATED APPLICATIONS

This application claims the benefit of priority to United Kingdom Patent Application No. 2403827.5 filed on Mar. 18, 2024. The entire contents of this application are hereby incorporated herein by reference.

### BACKGROUND OF THE INVENTION

### 1. Field of the Invention

The invention relates to self-oscillating flyback DC-DC converters which use the primary winding side circuit of a transformer to regulate the output voltage of a power supply.

### 2. Description of the Related Art

Switched-mode converters are DC-DC converters that supply DC loads with a regulated output voltage. Switched-mode converters offer a variety of advantages. For example, the power conversion efficiency is high, and hence, the passive components can be smaller and have lower losses, which simplify thermal management. The energy stored by an inductor can be transformed to output voltages that can be either smaller or greater than the input voltage. However, switch-mode converters are normally costly due to the complexity of the electronic circuitry employed.

The flyback converter is one type of switch mode converter in which energy is stored within the primary winding inductance of the transformer during a conduction phase (also called the on-state) of a power switch (e.g. a transistor) that is in series with the primary winding. The energy is then transferred to the secondary winding of the transformer during a subsequent phase of non-conduction of the switch (also called the off-state).

A self-oscillating flyback converter is a type of flyback converter which does not require a separate oscillator, and in which the switching of the primary current at the primary side of the transformer is achieved by a built-in self-oscillatory action. Hence, the self-oscillating flyback converter can be constructed with relatively few circuit components, without the need for dedicated integrated circuits. The self-oscillating flyback converter therefore provides a low cost solution in comparison to those converters using a PWM (pulse-width modulation) controller integrated circuit.

In a prior art example, in order to regulate the output to a fixed voltage, while the input voltage varies over a wide range, it is usually necessary to use an opto-isolator (also called an optocoupler, photocoupler, or optical isolator) controlled by a regulator. An opto-isolator is an electronic component that transfers electrical signals between two isolated circuits by using light, which is normally used to prevent high voltages from affecting the system receiving the signal. The regulator used to control the opto-isolator could be a TL431 integrated circuit, for example, which is a three-terminal adjustable precise shunt voltage regulator.

However, such a configuration can be expensive, and can take up a large area on printed circuit board. It can also add additional parasitic capacitance from output to input, which can be detrimental to electromagnetic compatibility performance and can increase common mode transient interference.

Therefore, it would be desirable to provide a regulating circuit at the primary side of a self-oscillating flyback converter that is low-cost and requires a lower number of circuit components without the need of integrated circuits.

### SUMMARY OF THE INVENTION

According to a first example embodiment of the present invention, there is provided a flyback converter including a transformer, a switching circuit and a regulating circuitry coupled with a primary winding circuit of the transformer. The switching circuit includes a primary switch which is switchable between an ON state and an OFF state and a switch coupled to the primary switch of the primary winding circuit. The switch is configured to change the state of the primary switch in response to a current change in the primary winding circuit under a normal operation. The regulating circuit includes a regulator coupled between the switch and the primary winding. The regulator is configured to feed an additional current to the switch in response to a voltage applied from the primary winding to the regulator. In response to the additional current fed by the regulator, the switch is urged to change the state of the primary switch earlier than under the normal operation.

Example embodiments of the present invention provide an efficient flyback converter topology which has a reduced input to output parasitic capacitance. Further, since no integrated circuit is required in the implementation, the longevity of the resulting device is improved.

The above and other elements, features, steps, characteristics and advantages of the present invention will become more apparent from the following detailed description of the example embodiments with reference to the attached drawings.

### BRIEF DESCRIPTION OF THE DRAWINGS

Example embodiments of the present invention will now be described by way of example and in relation to the accompanying drawings, in which:

FIG. 1 shows a schematic circuit diagram 100 of a flyback converter including a regulating circuitry 120 according to a first example embodiment of the present invention.

FIG. 2 shows a schematic circuit diagram 200 of a flyback converter including a regulating circuitry 220 according to a second example embodiment of the present invention.

FIG. 3 shows a schematic circuit diagram 300 of a flyback converter including a regulating circuitry 320 according to a third example embodiment of the present invention.

FIG. 4 shows a schematic circuit diagram 400 of a flyback converter including a regulating circuitry 420 according to a fourth example embodiment of the present invention.

FIG. 5 shows a schematic circuit diagram 500 of a flyback converter including a regulating circuitry 520 according to a fifth example embodiment of the present invention.

### DETAILED DESCRIPTION OF THE EXAMPLE EMBODIMENTS

This application relates to a flyback converter including voltage regulating circuitry provided at the primary side of the transformer. The regulating circuitry is coupled with a primary winding circuit of the transformer including a primary switch being switchable between an ON state and an OFF state. As will be explained in more detail below, the regulating circuitry includes a switch coupled to the primary switch of the primary winding circuit, the switch being configured to change the state of the primary switch in response to a current change in the primary winding circuit under a normal operation; and a regulator coupled between the switch and the primary winding circuit. The regulator is configured to feed an additional current to the switch in response to a voltage applied from the primary winding to the regulator, wherein in response to the additional current fed by the regulator, the switch is urged to change the state of the primary switch earlier than under normal operation.

In a standard flyback circuitry, primary and secondary side inductors that are arranged to define a transformer. The primary side includes the primary winding and an input voltage source, and the secondary side includes a secondary winding and an output load. The standard flyback circuit also includes a switch in series with the primary winding at the primary side. The standard flyback circuit also includes a diode and an output capacitor at the secondary side. The diode is configured to allow current to flow from the transformer to charge the output capacitor and the output load when the diode is forward-biased.

The standard flyback circuitry includes two configurations (or states) which are an ON state and an OFF state. In the ON state, the energy is transferred from the input voltage source to the transformer while at the same time the output capacitor supplies energy to the output load. In the OFF state, the energy is transferred from the transformer to the output load and the output capacitor.

Having briefly described a standard flyback circuitry, a first example embodiment of the present invention will now be described.

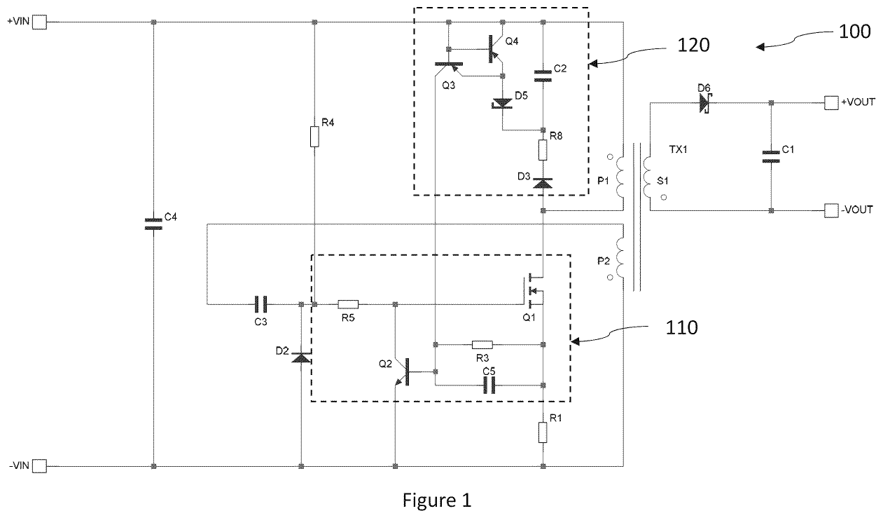

FIG. 1 shows a schematic circuit diagram 100 of a flyback converter including switching circuitry 110 and regulating circuitry 120 according to a first example embodiment of the present invention. As described above, the flyback converter circuit 100 includes a primary side and a secondary side. The primary side includes input terminals +VIN, −VIN, an input capacitor C4, a primary winding P1, a feedback winding P2 magnetically coupled to the primary winding P1, and a power switch (e.g. a transistor) Q1 connected in series with the primary winding P1 of a transformer TX1 that is coupled to an input voltage. In example embodiments, the power transistor Q1 may be a field-effect transistor, such as a junction transistor or a MOSFET. The primary side also includes a sensing resistor R4 that is connected between the power transistor Q1 and a common potential node of the circuit. The secondary side of the transformer TX1 includes a secondary winding S1, an output diode D6 coupled to the secondary winding S1, an output capacitor C1, output terminals +VOUT, −VOUT, and an output load.

When an input voltage is applied, a voltage is applied to the gate of the power transistor Q1 through the resistor R4. This causes the power transistor Q1 to turn on and current to flow through the primary winding P1 of the transformer TX1. The voltage across the primary winding P1 is reflected into the feedback winding P2 which is applied to the gate of the power transistor Q1 through a capacitor C3 and a resistor R5. The capacitor C3 and the resistor R5 are in series and are both coupled between the secondary winding P2 and the gate of the power transistor Q1. A diode d2 is connected between the input terminal-VIN and a common node between the capacitor C3 and the resistor R5.

The applied voltage from the feedback winding P2 to the gate of the power transistor Q1 enhances the gate voltage to the power transistor Q1, which causes the power transistor Q1 to fully saturate. At the same time, the voltage across the primary winding P1 is also reflected in the secondary winding S1. The reflected voltage across the secondary winding S1 is applied to the output diode D6. However, in this configuration which is an ON state, the output diode D6 is reverse-biased. Therefore, no current flows in the secondary side.

The transformer has a gapped core, and therefore has a defined inductance L which means the current ramps up linearly with time due to the rule:

$$V = - L \frac{di}{dT}$$

where V is the input voltage, L is the inductance, di is the rising current, and dT is the time.

The switching circuitry 110 of the flyback converter shown in FIG. 1 further includes a switch or switching means (e.g. a transistor) Q2 coupled to the gate of the power transistor Q1. In example embodiments, the switching transistor Q2 may be a field-effect transistor, such as a junction transistor or a MOSFET. The gate of the switching transistor Q2 is coupled to a resistor R3 and a capacitor C5 at a node where the resistor R3 and the capacitor R5 are connected in parallel. A current sensing resistor R1 is coupled to the resistor R3 and the capacitor C5 such that the rising current in the primary side circuit can pass through the current sense resistor R1 and produce a rising voltage at the base of Q2 through the resistor R3 and the capacitor C5.

When the voltage across the base of the switching transistor Q2 reaches about 0.6 V, within manufacturing and/or measurement tolerances, this causes the switching transistor Q2 to turn ON which forces the gate of the power transistor Q1 to turn OFF. This is because, when the switching transistor Q2 is turned ON, it causes a short circuit at the gate of the power transistor Q1. When the power transistor Q1 turns OFF, the voltage in the primary winding P1, the feedback winding P2, and the secondary winding S1 reverses. The reversed voltage applied to the feedback winding P2 enhances the turning off of the power transistor Q1. The voltage across the secondary winding S1 is therefore applied to the output diode D6 in a forward-biasing direction. The energy stored in the transformer TX1 is hence delivered to the output capacitor C1 and to any output load attached.

At this stage, the current tends to ramp down in the secondary winding S1 due to the same rule:

$$V = - L \frac{di}{dT}$$

where V is the secondary winding voltage, L is the secondary winding inductance, and dT is time.

When all the energy is removed from the transformer TX1, the voltage in the secondary winding S1 collapses, and this is again reflected in the primary winding P1 and the feedback winding P2. This also results in a discharge of the capacitor C5 at the gate of the switching transistor Q2 which therefore leads to the switching transistor Q2 to switch off. Therefore, a voltage input is again applied to the gate of the power transistor Q1, and the whole cycle starts again.

The transformer TX1 is designed to have enough inductance to provide more than enough energy stored to power the output at full load when the input voltage is at a minimum. The energy stored in the transformer TX1 is as follows:

E=Li²

where E is the energy, L is the primary inductance, and i is the current. The corresponding power is as follow:

P=Et

where P is the power, E is the energy stored, and t is the time.

When the input voltage is higher than the minimum or the load on the output is low, it can be desirable to regulate the output voltage and to terminate the energy delivery to the output earlier. This is done by feeding an additional DC current into the base of the switching transistor Q2 so that the voltage at the base of the switching transistor Q2 reaches a voltage threshold, such as about 0.6V, within manufacturing and/or measurement tolerances, at an earlier time than normal. Therefore, a regulating circuitry that can generate an additional DC current and feed to the base of the switching transistor Q2 can therefore be desirable.

FIG. 1 shows a regulating circuit 120 according to a first example embodiment of the present invention. The regulating circuit 120 includes a diode D3; a resistor R8 that is in series with the diode D3; a capacitor C2 that is coupled between a common potential node and the resistor R8; a transistor Q3 and a transistor Q4 defining a current mirror in which the collector of the transistor Q3 is connected to the gate of the switching transistor Q2; and a diode D5 connected between the common node between the capacitor C2 and the resistor R8 and the current mirror defined by transistors Q3 and Q4. In some example embodiments, the diode D5 may be a Zener diode which reliably allows current to flow “backwards” when a certain set reverse voltage, known as the Zener voltage, is reached. The base terminals of both transistors Q3 and Q4 are connected to the Vin power line, connected to one end of the primary winding P1.

The regulating circuit 120 is also coupled to the primary winding P1 through the diode D3. A reversed voltage in the primary winding P1 during the turn-off period of the power transistor Q1 is transferred to and stored in the capacitor C2. When the voltage across C2 is high enough to bias the Zener diode D5, the Zener diode conducts current into the emitter of transistor Q4. Since the transistors Q4 and Q3 are connected as a current mirror, any current in the transistor Q4 will be mirrored in the transistor Q3 regardless of the voltage differences of the collectors of Q4 and Q3. This causes a current to conduct from the transistor Q3 down to the switching transistor Q2 in the switching circuitry 110. This achieves the feeding in of an additional current into the switching transistor Q2, which makes the voltage across the switching transistor Q2 rise above the voltage threshold (e.g. about 0.6 V, within manufacturing and/or measurement tolerances) earlier than under normal conditions (e.g. when no regulating circuit 120 is provided), which in turn forces the power transistor Q1 to switch off earlier. In this way, the regulating circuit 120 controls the ON/OFF time period of the power transistor Q1 in the switching circuitry 110. Since the reflected voltage of the primary winding P1 is directly related to the voltage delivered to the output of the flyback converter 100 through the secondary winding S1, the primary side regulating circuit 120 therefore regulates the output voltage.

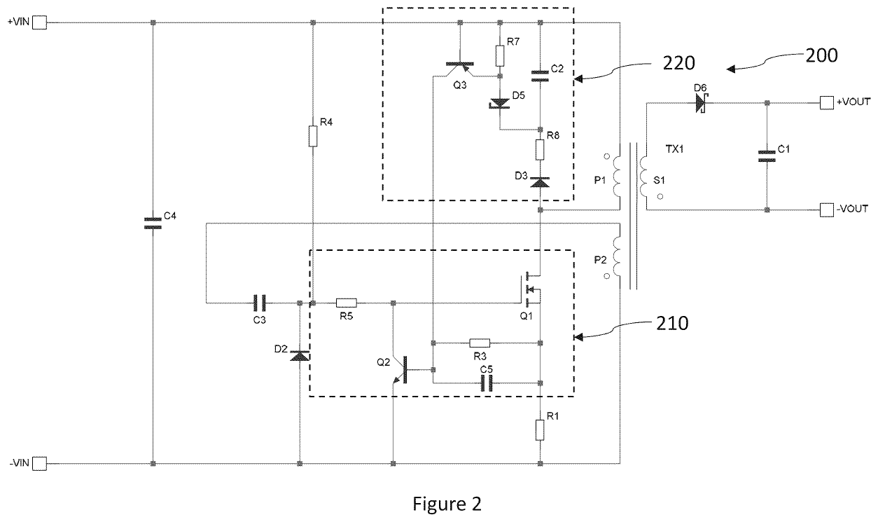

There are several alternative ways to deliver an additional DC current through a regulating circuit which are described in the various example embodiments shown in FIGS. 2 to 5. The switching circuits 210, 310, 410, and 510 of FIGS. 2 to 5 are illustrated as identical to switching circuit 110 shown in FIG. 1.

FIG. 2 shows a regulating circuit 220 according to a second example embodiment of the present invention. The regulating circuit 220 includes a diode D3; a resistor R8 that is in series with the diode D3; a capacitor C2 that is coupled between a common potential node and the resistor R8; a resistor R7 in series with a diode D5 in which the resistor R7 and the diode D5 are connected in parallel with the capacitor C2; and a transistor Q3 in which the gate of the transistor Q3 is connected to the common potential node and in which the collector of the transistor Q3 is connected to the gate of the switching transistor Q2. The regulating circuit 220 is coupled to the primary winding P1 through the diode D3. In this example embodiment, the second transistor Q4 of the first example embodiment is replaced by the resistor R7.

Compared to the first example embodiment, the second example embodiment uses a current sense switch, transistor Q3, provided below the Zener diode D5. This arrangement uses fewer components but offers a higher gain, since the current to switching transistor Q2 is effectively gated by the voltage on the resistor R7. In example embodiments, this boosted gain can be adjusted down by placing an additional resistor in the current path between switching transistor Q2 and transistor Q3.

The first example embodiment uses a current mirror, offering stability since the Zener diode current is reflected exactly in magnitude to the base of transistor Q2.

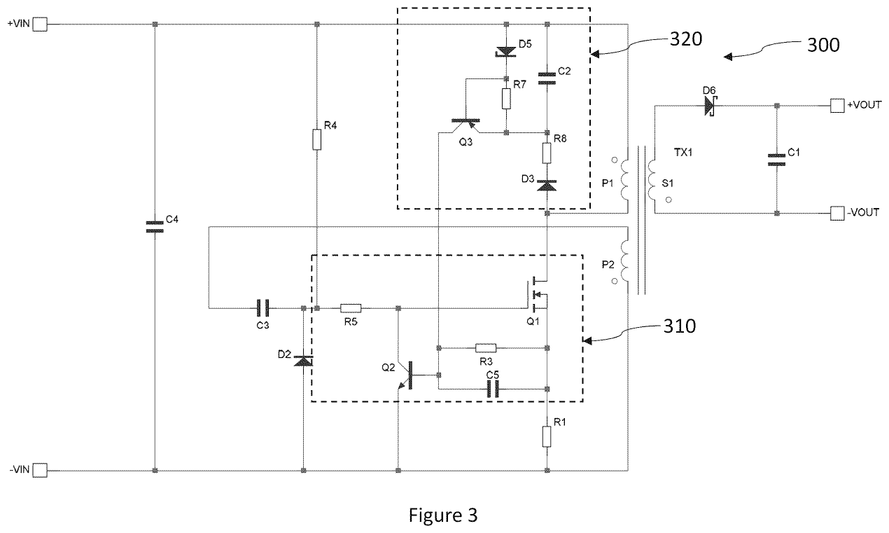

FIG. 3 shows a regulating circuit 320 according to a third example embodiment of the present invention. The regulating circuit 320 includes a diode D3; a resistor R8 that is in series with the diode D3; a capacitor C2 that is coupled between a common potential node and the resistor R8; a resistor R7 in series with a diode D5 in which the resistor R7 and the diode D5 are connected in parallel with the capacitor C2; and a transistor Q3 in which the gate of the transistor Q3 is connected to a node between the diode D5 and the resistor R7 that are in series with each other and the collector of the transistor Q3 is connected to the gate of the switching transistor Q2. The regulating circuit 320 is coupled to the primary winding P1 through the diode D3. In this example embodiment, the diode D5 is connected to the Vin power line, and the transistor Q3 is connected across the resistor R7 as before, with the base connection of the transistor Q3 connected to a point intermediate of the diode D5 and the resistor R7, which together define a voltage divider.

Compared to the first example embodiment, the third example embodiment uses a current sense switch, transistor Q3, provided above the Zener diode D5. This arrangement uses fewer components but offers a higher gain, since the current to the transistor Q2 is effectively gated by the voltage on the resistor R7. In example embodiments, this boosted gain can be adjusted down again by placing an additional resistor in the current path between switching transistor Q2 and transistor Q3.

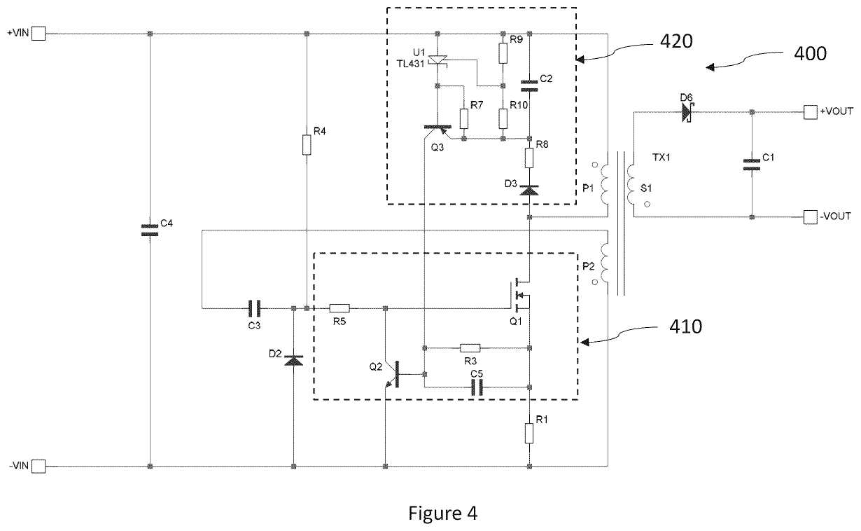

FIG. 4 shows a regulating circuit 420 according to a fourth example embodiment of the present invention. The regulating circuit 420 includes a diode D3; a resistor R8 that is in series with the diode D3; a capacitor C2 that is coupled between a common potential node and the resistor R8; a voltage divider defined by a resistor R9 and a resistor R10, and wherein the voltage divider is connected across the capacitor C2; a transistor Q3 where the collector of the transistor Q3 is connected to the gate of the switching transistor Q2; a resistor R7 connected between the gate and the emitter of the transistor Q3; and a three terminal shunt regulator U1 connected between the base of the transistor Q3 and the power line Vin, with a control terminal for the shunt regulator U1 being connected to the intermediate node between the voltage divider defined by resistors R9 and R10. The shunt regulator may be a TL431 regulator, for example. The regulating circuit 420 is coupled to the primary winding P1 through the diode D3.

Compared to the first example embodiment, the fourth example embodiment uses a current sense switch, transistor Q3, provided above the shunt regulator U1. This arrangement uses more components than some of the other example embodiments, but also provides improvements in accuracy and temperature stability. In example embodiments, the gain at switching transistor Q2 can be adjusted down by placing an additional resistor in the current path between switching transistor Q2 and transistor Q3.

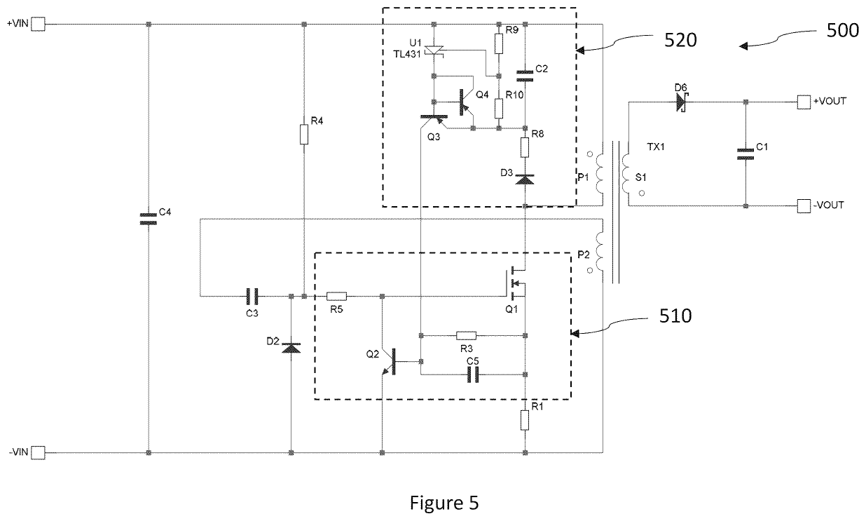

FIG. 5 shows a regulating circuit 520 according to a fifth example embodiment of the present invention. The regulating circuit 520 includes a diode D3; a resistor R8 that is in series with the diode D3; a capacitor C2 that is coupled between a common potential node and the resistor R8; a voltage divider defined by a resistor R9 and a resistor R10 in which the voltage divider is connected across the capacitor C2; a current mirror defined by a transistor Q3 and a transistor Q4 in which the collector of the transistor Q3 is connected to the gate of the switching transistor Q2; the base terminal of the transistors Q3 and Q4 are collected to the low voltage side of a three terminal shunt regulator connected between the transistors Q3 and Q4 and the input power line Vin. The regulator terminal of the shunt regulator connected to a node between the voltage divider by resistors R9 and R10 and connected to a common node of the gates of transistors Q3 and Q4. The regulating circuit 520 is coupled to the primary winding P1 through the diode D3.

Compared to the first example embodiment, the fifth example embodiment uses a current mirror provided above the shunt regulator U1. This arrangement is highly stable and provides improvements in accuracy and temperature stability.

The example embodiments described above provide an efficient flyback converter topology which has a reduced input to output parasitic capacitance. Further, since no integrated circuit is required for the implementation, the longevity of the resulting device is improved.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A flyback converter comprising:
a transformer including a primary winding;
a switching circuit including a primary switch which is switchable between an ON state and an OFF state;
a regulating circuit coupled with a primary winding circuit connected to the transformer; and
a switch coupled to the primary switch; wherein
the switch is configured to change a state of the primary switch in response to a current change in the primary winding circuit under a normal operation;
the regulating circuit includes a regulator coupled between the switch and the primary winding;
the regulator is configured to feed an additional current to the switch in response to a voltage applied from the primary winding to the regulator; and
in response to the additional current fed by the regulator, the switch changes the state of the primary switch earlier than under the normal operation.

2. The flyback converter according to claim 1, wherein the switch is configured to change the state of the primary switch from the ON state to the OFF state when a voltage across the switch is above a voltage threshold in response to a current increase in the primary winding circuit.

3. The flyback converter according to claim 1, wherein the voltage applied from the primary winding to the regulator is a reverse voltage generated from the primary winding circuit when the primary switch is in the OFF state.

4. The flyback converter according to claim 1, wherein the regulator includes a circuit including:
a capacitor coupled to the primary winding, the capacitor is configured to store the voltage applied from the primary winding to the regulator;
a first transistor coupled between the capacitor and the switch; and
a rectifying component coupled between the capacitor and the first transistor, the rectifying component is configured to direct a generated current to the first transistor when a voltage across the capacitor is higher than a second voltage threshold, wherein
the generated current is fed to the switch through the first transistor.

5. The flyback converter according to claim 4, wherein the rectifying component includes a Zener diode.

6. The flyback converter according to claim 4, wherein the regulator further includes a diode coupled between the capacitor and the primary winding.

7. The flyback converter according to claim 6, wherein the regulator further includes a first resistor in series with the diode.

8. The flyback converter according to claim 4, wherein
the regulator further includes a second transistor coupled between the first transistor and the rectifying component; and
the second transistor is configured to define a current mirror with the first transistor and is configured to mirror the current directed from the rectifying component to the first transistor.

9. The flyback converter according to claim 8, wherein the regulator further includes a voltage regulator coupled between the capacitor and the current mirror.

10. The flyback converter according to claim 9, wherein the voltage regulator includes a TL431 integrated circuit.

11. The flyback converter according to claim 4, wherein the regulator further includes a second resistor coupled to the first transistor.

12. The flyback converter according to claim 4, wherein the regulator further includes a voltage regulator coupled between the first transistor and the capacitor.

13. The flyback converter according to claim 12, wherein the voltage regulator includes a TL431 integrated circuit.

14. The flyback converter according to claim 1, wherein the primary switch includes a transistor.

15. The flyback converter according to claim 1, wherein the first voltage threshold of the second switch is about 0.6 V.

16. The flyback converter according to claim 1, wherein the switch includes a transistor.

17. A method for regulating an output voltage of a flyback converter in which a regulating circuitry is coupled with a primary winding circuit of a transformer including a primary switch being switchable between an ON state and an OFF state, the method comprising:
applying a voltage generated from a primary winding of the transformer to a regulator, wherein the regulator is coupled between a switch and the primary winding circuit, the switch is coupled to the primary switch, and the switch is configured to change a state of the primary switch in response to a current change in the primary winding circuit under a normal operation;
generating, by the regulator, an additional current in response to a voltage applied from the primary winding;
feeding, by the regulator, the additional current to the switch;
changing, by the switch, the state of the primary switch in response to the additional current fed to the switch, wherein the switch changes the state of the primary switch earlier than under the normal operation.

18. The method according to claim 17, wherein the switch is configured to change the state of the primary switch from the ON state to the OFF state when a voltage across the switch is above a voltage threshold in response to a current increase in the primary winding circuit.

19. The method according to claim 17, wherein the voltage applied from the primary winding to the regulator includes a reverse voltage generated from the primary winding circuit when the primary switch is in the OFF state.

20. The method according to claim 17, further comprising:
storing the voltage applied from the primary winding in a capacitor coupled to the primary winding;
generating a current when a voltage across the capacitor is higher than a second voltage threshold; and
directing, by a rectifying component, the current to a first transistor in the regulator.

21. The method according to claim 20, wherein the rectifying component includes a Zener diode.

22. The method according to claim 20, further comprising coupling a diode between the capacitor and the primary winding.

23. The method according to claim 22, further comprising coupling a first resistor in series with the diode.

24. The method according to claim 20, further comprising coupling a second transistor between the first transistor and the rectifying component, wherein
the second transistor is configured to define a current mirror with the first transistor and is configured to mirror the current directed from the rectifying component to the first transistor.

25. The method according to claim 24, further comprising coupling a voltage regulator between the capacitor and the current mirror.
